(19) United States
(12) Patent Application Publication
(10) Pub. No.: US 2015/0193417 A1
(43) Pub. Date: Jul. 9, 2015

(54) INFORMATION PROCESSING SYSTEM, INFORMATION PROCESSING APPARATUS AND INFORMATION PROCESSING METHOD

(71) Applicant: Teruyoshi YAMAMOTO, Tokyo (JP)

(72) Inventor: Teruyoshi YAMAMOTO, Tokyo (JP)

(21) Appl. No.: 14/575,023

(22) Filed: Dec. 18, 2014

(30) Foreign Application Priority Data
Jan. 6, 2014 (JP) 2014-000559

(51) Int. Cl. G06F 17/24; G06K 15/02; G06K 15/00

(52) U.S. Cl. CPC G06F 17/243; G06K 15/007; G06K 15/02

(57) ABSTRACT

The system includes a receiving part receiving a user's operation, a submission form acquisition part that acquires submission form information including at least a template of a submission document differing among communities and among public offices and updating information indicating an updating-time-point when the receiving part receives an instruction to print the submission document, an updating part that compares the updating information about preliminarily retained submission form information with the updating information about the submission form information and, when the acquired updating information is newer than the updating about preliminarily retained submission form information, updates the submission form information, and a printing control part that produces data for printing in which personal information corresponding to an input item included in the submission form information is input to the input item from a personal information group including one or more pieces of preliminarily registered personal information, and prints the submission document.

### CROSS-REFERENCE TO RELATED APPLICATIONS

The present application claims priority to and incorporates by reference the entire contents of Japanese Patent Application No. 2014-000559 filed in Japan on Jan. 6, 2014.

### BACKGROUND OF THE INVENTION

1. Field of the Invention

The present invention relates to an information processing system, an information processing apparatus and an information processing method.

2. Description of the Related Art

Application form generation systems have been known in which submission documents are produced using electronic forms and the produced documents are transmitted to communities and public offices as computerized information.

For example, Japanese Patent Application Laid-open No. 2007-226333 discloses an application form generation system. Using this system, an applicant can readily and automatically produce an application form attached with an identification photograph in a short period of time. The application form generation system described in Japanese Patent Application Laid-open No. 2007-226333 includes a database storing therein application document information and a kiosk terminal that is provided with a camera and operated by an applicant using the applicant's integrated circuit (IC) cash card for producing an application document. The kiosk terminal reads the applicant's personal information from the IC cash card, photographs the applicant, and issues an application document in which the personal information is written and to which an identification photograph is attached.

The application form generation system described in Japanese Patent Application Laid-open No. 2007-226333, however, has a problem in that submission documents fail to be produced in the latest application forms when the application document information about templates of submission documents, which differ among communities and among public offices, is not updated.

In view of the above, there is a need to provide an information processing system, an information processing apparatus and an information processing method that can produce various submission documents by acquiring the latest submission forms of the templates of the submission documents, which differ among communities and among public offices.

### SUMMARY OF THE INVENTION

It is an object of the present invention to at least partially solve the problems in the conventional technology.

According to the present invention, there is provided an information processing system, comprising: a receiving part that receives operation of a user; a submission form acquisition part that acquires submission form information including at least a template of a submission document differing among communities and among public offices and updating information indicating an updating time point, when the receiving part receives an instruction to print the submission document; an updating part that compares the updating information about the submission form information preliminarily retained with the updating information about the acquired submission form information, and updates the submission form information about the submission document when the acquired updating information is newer than the updating information about the submission form information preliminarily retained; and a printing control part that produces data for printing in which personal information corresponding to an input item included in the submission form information is input to the input item from a personal information group including one or more pieces of preliminarily registered personal information, and prints the submission document.

The present invention also provides an information processing apparatus, comprising: a receiving part that receives operation of a user; a display part that displays various images; an authentication control part that performs control in relation to authentication of a user; a submission form acquisition part that acquires submission form information including at least a template of a submission document differing among communities and among public offices and updating information indicating an updating time point, when the receiving part receives an instruction to print the submission document; an updating part that compares the updating information about the submission form information preliminarily retained with the updating information about the acquired submission form information, and updates the submission form information about the submission document when the acquired updating information is newer than the updating information about the submission form information preliminarily retained; a storage that retains the acquired submission form information; a printing control part that produces data for printing in which personal information corresponding to an input item included in the submission form information is input to the input item from a personal information group including one or more pieces of preliminarily registered personal information after the authentication control part performs the authentication of the user when the receiving part receives the instruction to print the submission document, and prints the submission document; and a communication part that exchanges various types of data with an external apparatus.

The present invention also provides an information processing method, comprising: receiving operation of a user; acquiring submission form information including at least a template of a submission document differing among communities and among public offices and updating information indicating an updating time point, when an instruction to print the submission document is received at the receiving; comparing the updating information about the submission form information preliminarily retained with the updating information about the acquired submission form information, and updating the submission form information about the submission document when the acquired updating information is newer than the updating information about the submission form information preliminarily retained; and producing data for printing in which personal information corresponding to an input item included in the submission form information is input to the input item from a personal information group including one or more pieces of preliminarily registered personal information, and printing the submission document.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an exemplary hardware structure of an information processing system according to an embodiment of the present invention;

FIG. 2 is a schematic diagram illustrating an exemplary software structure of a multifunction peripheral (MFP) according to the embodiment;

FIG. 3 is a schematic diagram illustrating exemplary functional structures of the MFP and a server according to the embodiment;

FIG. 4 is a schematic diagram illustrating an example of a home screen;

FIG. 5 is a schematic diagram illustrating an example of a selection screen displayed just after starting of a simple printing application for submission forms of respective communities and public offices;

FIG. 6 is a schematic diagram illustrating an example of a selection screen displayed just after selection of printing for specific purposes;

FIG. 7 is a schematic diagram illustrating an example of a selection screen for selecting a user who instructs printing;

FIG. 8 is a schematic diagram illustrating an example of a login screen;

FIG. 9 is a schematic diagram illustrating an example of a screen for input of personal information data;

FIG. 10 is a flowchart illustrating an example of processing operation when an instruction for printing is received;

FIG. 11 is a flowchart illustrating processing to produce data for printing in which personal information corresponding to an input item included in submission form information is input to the input item from a personal information group; and

FIG. 12 is a flowchart illustrating an example of processing operation to acquire the submission form information from servers installed in communities and public offices.

### DETAILED DESCRIPTION OF THE PREFERRED EMBODIMENTS

The following describes embodiments of an information processing system, an information processing apparatus, an information processing method, a computer program, and a recording medium according to the invention in detail with reference to the accompanying drawings. The invention is not limited by the following embodiment. Embodiments can be combined as appropriate without inconsistency among them. In the following embodiment, the information processing apparatus according to the invention is applied to a multifunction peripheral (MFP). However, the embodiment is not limited thereto. The MFP has at least two functions out of printing, copying, scanner, and facsimile functions.

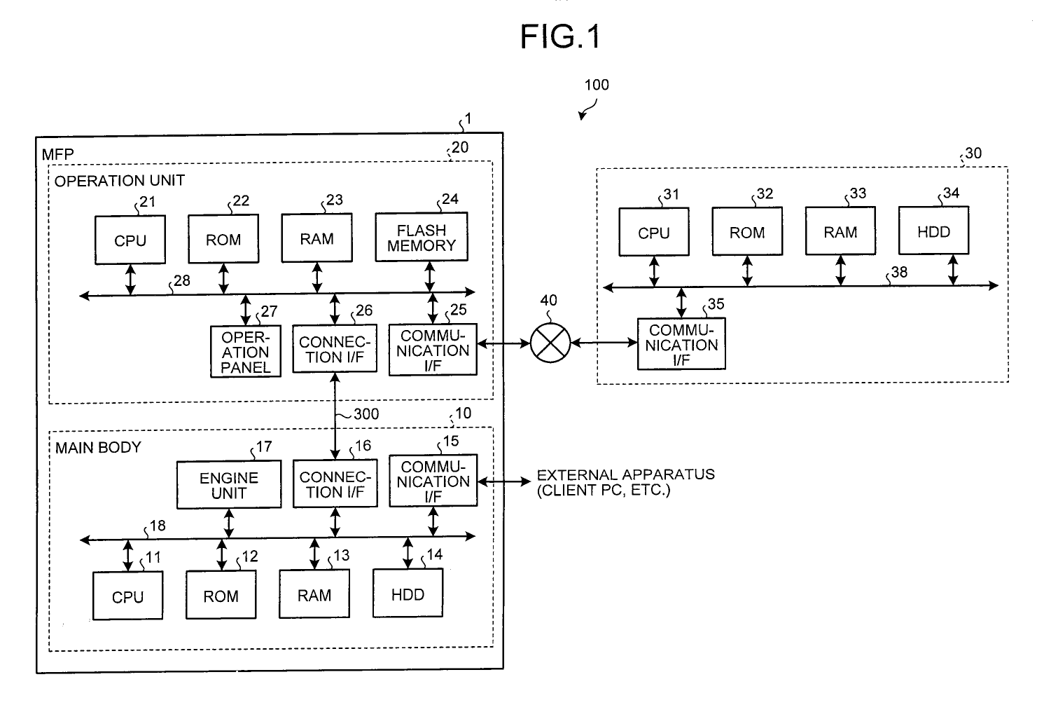

FIG. 1 is a block diagram illustrating an exemplary hardware structure of an information processing system according to the embodiment. As illustrated in FIG. 1, an information processing system 100 includes an MFP 1 and a server 30. The MFP 1 is connected to the server 30 via a network 40 such as the Internet. While one MFP 1 is connected to the server 30 in the example of FIG. 1, the number of MFPs 1 is not limited to this example and any number of MFPs 1 may be connected to the server 30. In a similar manner, while one server 30 is connected to the MFP 1 in the example of FIG. 1, the number of servers 30 is not limited to this example and any number of servers 30 may be connected to the MFP 1.

As illustrated in FIG. 1, the MFP 1 includes a main body 10 that can achieve various functions such as copier, scanner, facsimile, and printer functions, and an operation unit 20 that receives input according to the user's operation. The main body 10 and the operation unit 20 are connected via a dedicated communication path 300 so as to enable communication with each other. The communication path 300 is compliant with a universal serial bus (USB) standard, for example. The communication path 300 may be compliant with any standard regardless of a wireless or wire-based communication scheme.

The main body 10 can operate in accordance with the input received by the operation unit 20. The main body 10 can communicate with an external apparatus such as a client personal computer (PC) and also operate in accordance with an instruction received from the external apparatus.

The hardware structure of the main body 10 is described below. As illustrated in FIG. 1, the main body 10 includes a central processing unit (CPU) 11, a read only memory (ROM) 12, a random access memory (RAM) 13, a hard disk drive (HDD) 14, a communication interface (I/F) 15, a connection I/F 16, and an engine unit 17. These components are mutually connected via a system bus 18.

The CPU 11 controls the overall operation of the main body 10. The CPU 11 executes a computer program stored in the ROM 12 or the HDD 14, for example, using the RAM 13 as a working area to control the overall operation of the main body 10, thereby achieving the various functions such as the copier, scanner, facsimile, and printer functions.

The communication I/F 15 is an interface to communicate with the external apparatus such as the client PC. The connection I/F 16 is an interface to communicate with the operation unit 20 via the communication path 300.

The engine unit 17 is hardware that performs versatile information processing and processing other than communication for achieving the copier, scanner, facsimile, and printer functions. The engine unit 17 includes a scanner (image reading section) that scans and reads an image on a document, a plotter (image forming section) that performs printing on a sheet material such as paper, and a facsimile section that performs facsimile communication, for example. The engine unit 17 may further include specific options such as a finisher that sorts the sheet materials after printing and an automatic document feeder (ADF) that automatically feeds documents.

The hardware structure of the operation unit 20 is described below. As illustrated in FIG. 1, the operation unit 20 includes a CPU 21, a ROM 22, a RAM 23, a flash memory 24, a communication I/F 25, a connection I/F 26, and an operation panel 27. These components are mutually connected via a system bus 28.

The CPU 21 controls the overall operation of the operation unit 20. The CPU 21 executes a computer program stored in the ROM 22 or the flash memory 24, for example, using the RAM 23 as a working area to control the overall operation of the operation unit 20, thereby achieving various functions such as displaying of information (images) according to the input received from a user, which functions are described later.

The communication I/F 25 is an interface to perform communication with the server 30 via the network 40. The connection I/F 26 is an interface to communicate with the main body 10 via the communication path 300.

The operation panel 27 receives various types of input according to the user's operation and displays various types of information (e.g., information according to the received input, information indicating an operation status of the MFP 1, and information indicating a setting condition). In this example, the operation panel 27 includes a liquid crystal display (LCD) having a touch panel function, but the embodiment is not limited thereto. For example, the operation panel 27 may include an organic electroluminescence (EL) display having a touch panel function. Furthermore, in addition to or in place of these, the operation panel 27 may be provided with an operation unit such as hardware keys and a display part such as a lamp.

The hardware structure of the server 30 is described below. As illustrated in FIG. 1, the server 30 includes a CPU 31, a ROM 32, a RAM 33, an HDD 34, and a communication I/F 35. These components are mutually connected via a system bus 38.

The CPU 31 controls the overall operation of the server 30. The CPU 31 executes a computer program stored in the ROM 32 or the HDD 34, for example, using the RAM 33 as a working area to control the overall operation of the server 30, thereby achieving various functions, which are described later. The communication I/F 35 is an interface to perform communication with the operation unit 20 via the network 40.

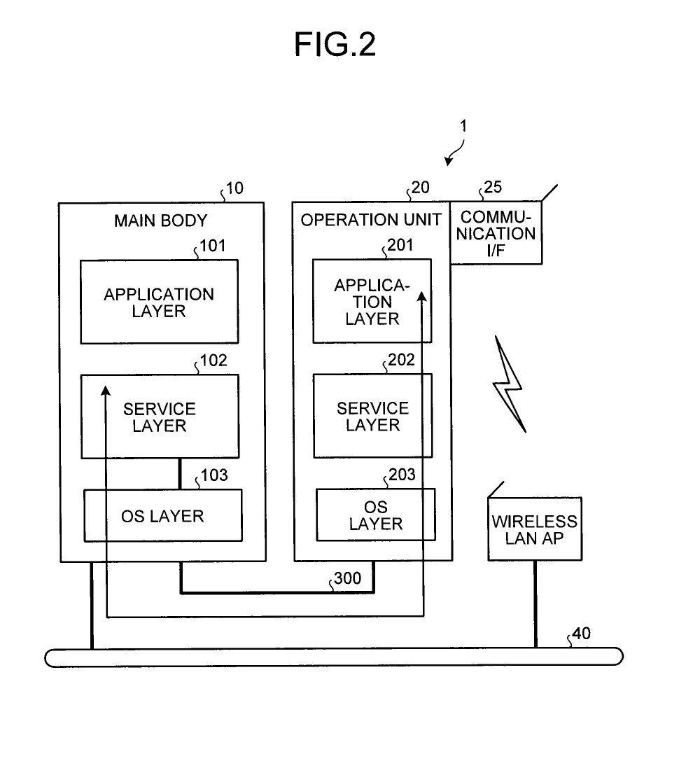

A software structure of the MFP 1 is described below. FIG. 2 is a schematic diagram illustrating an exemplary software structure of the MFP 1. As illustrated in FIG. 2, the main body 10 includes an application layer 101, a service layer 102, and an operating system (OS) layer 103. The application layer 101, the service layer 102, and the OS layer 103 are in fact various types of software stored in the ROM 12 and the HDD 14, for example. The CPU 11 executes the various types of software to provide the various functions.

The application layer 101 is application software (in the following description, may be described simply as the “application” in some cases) that causes the hardware resources to operate and provide a certain function. Examples of the application include a copy application that provides the copier function, a scanner application that provides the scanner function, a facsimile application that provides the facsimile function, and a printer application that provides the printer function.

The service layer 102, which is present between the application layer 101 and the OS layer 103, is software that provides an interface to the applications for using the hardware resources included in the main body 10. More specifically, the service layer 102 receives requests to operate the hardware resources and provides the function to arbitrate the operation requests. Examples of the operation requests received by the service layer 102 include a request for the scanner to perform reading and a request for the plotter to perform printing.

The interface function of the service layer 102 is provided to not only the application layer 101 of the main body 10 but also an application layer 201 of the operation unit 20. The application layer 201 (application) of the operation unit 20 can thus also achieve the functions using the hardware resources (e.g., the engine unit 17) of the main body 10 via the interface function of the service layer 102.

The OS layer 103 is basic software (operating system) that provides a basic function to control the hardware included in the main body 10. The service layer 102 is software that converts requests to use the hardware resources from the various applications into commands that the OS layer 103 can interpret, and then transfers the commands to the OS layer 103. The OS layer 103 executes the commands. As a result, the hardware resources operate in accordance with the requests from the applications.

The operation unit 20 includes the application layer 201, a service layer 202, and an OS layer 203. The hierarchy among the application layer 201, the service layer 202, and the OS layer 203 of the operation unit 20 is the same as that of the main body 10. The functions provided by the application layer 201 and the types of operation requests that the service layer 202 can receive differ from those of the main body 10. The application layer 201 is application software that causes the hardware resources included in the operation unit 20 to provide a certain function. Examples of the application layer 201 include software that provides a user interface (UI) function to perform operation on the functions (the printer function, the copier function, the scanner function, and the facsimile function) of the main body 10 and to perform displaying, and software that provides a function to simply print out submission documents differing among communities and among public offices (in the following description, may be described as a “simple printing application for submission forms of respective communities and public offices” or a “submission document simple printing application” in some cases).

The embodiment describes an example where the software of the OS layer 103 of the main body 10 and the software of the OS layer 203 of the operation unit 20 differ from each other in order to keep independence between the functions of the main body 10 and the operation unit 20. The main body 10 and the operation unit 20 thus operate independently from each other under the different operating systems. For example, Linux (registered trademark) is adopted as the software of the OS layer 103 of the main body 10, while Android (registered trademark) is adopted as the software of the OS layer 203 of the operation unit 20.

As described above, the main body 10 and the operation unit 20 operate under different operating systems in the MFP 1 according to the embodiment. The communication between the main body 10 and the operation unit 20 is thus not performed as an inter-process communication in a common apparatus, but as a communication between different apparatuses. Examples of the communication performed as that between different apparatuses include the operation (command communication) of transmission of the input (a content of the instruction by the user's operation) received by the operation unit 20 to the main body 10, and the operation of the main body 10 to notify the operation unit 20 of an event. The operation unit 20 can thus use the functions of the main body 10 by performing the command communication with the main body 10. Examples of the event notified to the operation unit 20 from the main body 10 include an implementation state of the operation in the main body 10 and contents set by the main body 10.

In the embodiment, power is supplied to the operation unit 20 from the main body 10 via the communication path 300. The power source control of the operation unit 20 can be performed separately (independently) from the power source control of the main body 10.

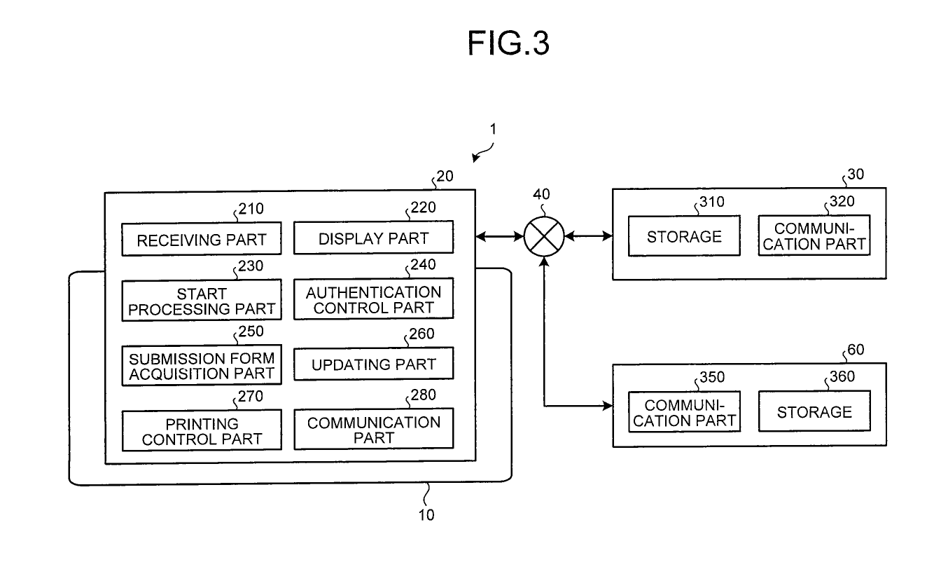

The following describes the functions of the MFP 1 and the server 30 with reference to FIG. 3. FIG. 3 is a schematic diagram illustrating exemplary functional structures of the MFP and the server according to the embodiment. FIG. 3 also illustrates a server 60, which is one of the servers 60 installed in communities and public offices, and with which the MFP 1 and the server 30 communicate. The following description is focused on the function in relation to the “simple printing application for submission forms of respective communities and public offices”, which is the application used by the MFP 1 to simply print and output submission documents differing among communities and among public offices.

The function of the MFP 1 is described below. As illustrated in FIG. 3, the operation unit 20 includes a receiving part 210, a display part 220, a start processing part 230, an authentication control part 240, a submission form acquisition part 250, an updating part 260, a printing control part 270, and a communication part 280.

The receiving part 210 receives various types of input. In this example, the receiving part 210 receives the input from the user's touch operation on a screen (surface on which an image is displayed) of the operation panel 27 having a touch panel function.

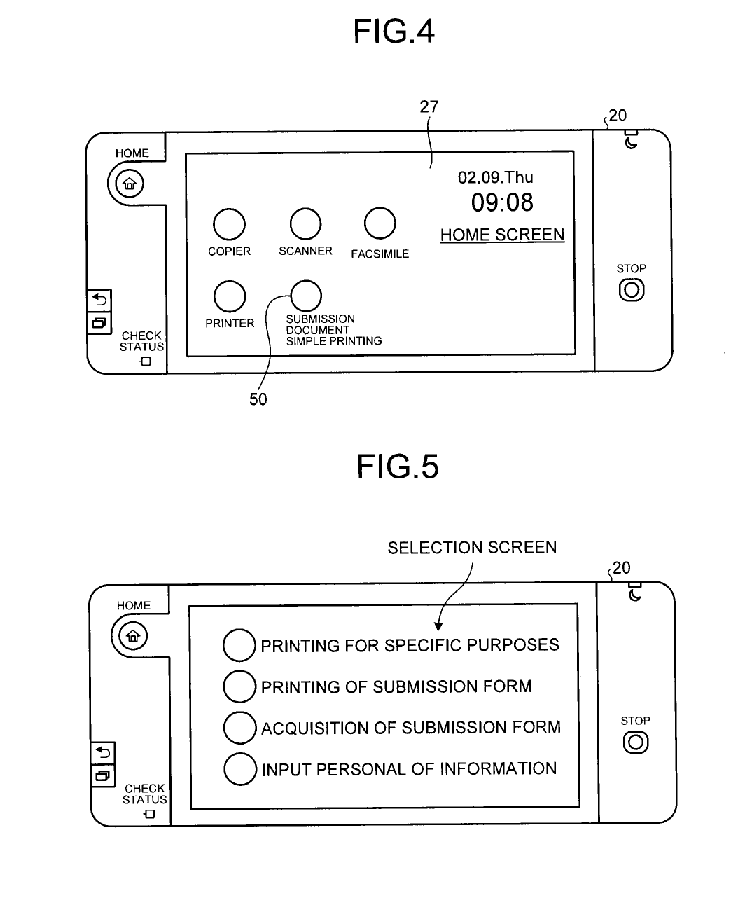

The display part 220 performs control such that various images are displayed on the operation panel 27. Just after the start of the MFP 1 or in a state where the user performs no operation, the display part 220 performs control such that a home screen illustrated in FIG. 4 is displayed on the operation panel 27. As illustrated in FIG. 4, a plurality of icons each corresponding to one of a plurality of types of applications are displayed on the home screen. In the embodiment, the application layer 201 of the operation unit 20 is the “simple printing application for submission forms of respective communities and public offices” and an icon 50 corresponding to the “simple printing application for submission forms of respective communities and public offices (submission document simple printing application)” is displayed on the home screen.

Referring back to FIG. 3, the start processing part 230 starts any of the applications in accordance with the user's input. In the embodiment, when the receiving part 210 receives the input by the touch operation on any icon while the home screen is displayed, the start processing part 230 performs control so as to start the application corresponding to the icon on which the touch operation is performed. For example, when the user performs operation to touch the icon 50 corresponding to the simple printing application for submission forms of respective communities and public offices, the start processing part 230 performs control so as to start the simple printing application for submission forms of respective communities and public offices. In this example, when the simple printing application for submission forms of respective communities and public offices is started, the display part 220 displays a selection screen, which is displayed just after the start of the simple printing application for submission forms of respective communities and public offices, as illustrated in FIG. 5. In the example of FIG. 5, the display part 220 performs control so as to display the selection screen that promotes the user to select any of designation of printing for specific purposes, designation of printing a submission form, designation of acquisition of a submission form, and designation of input of personal information data.

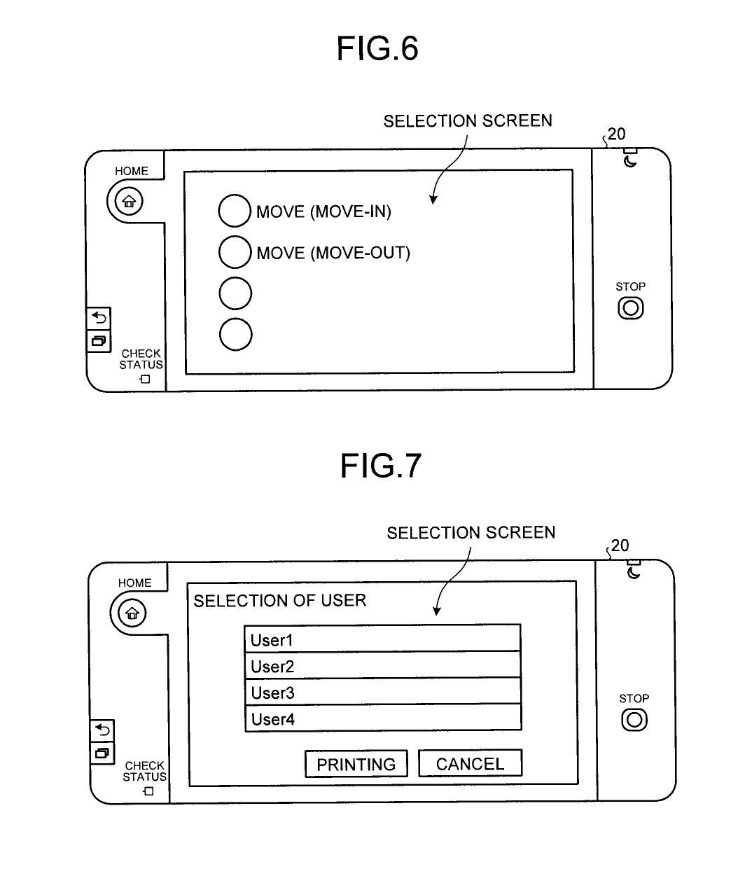

When the printing for specific purposes is selected, a set of submission form information is automatically acquired. The submission form information includes at least a template of a submission document for a purpose and updating information indicating an updating time point. For example, when the user selects the icon designating the printing for specific purposes, control is performed such that the icon designating whether “move (move-in)” or “move (move-out)” is displayed as illustrated in FIG. 6. For example, when the user selects the icon designating the “move (move-in)” in the selection screen at the time of the “move (move-in)”, a set of submission form information (e.g., for a public office, a gas company, a waterworks department, and a power company) of submission documents that should be submitted at the time of the move (move-in) is automatically selected and acquired. As a result, the load on the user to prepare the submission documents for application is reduced.

The following describes an example where the user selects the icon designating the “move (move-in)”. As illustrated in FIG. 7, when the user selects the icon designating the “move (move-in)”, the display part 220 displays the screen for selecting the user who instructs printing. The user selects the user who instructs printing and then selects the icon designating printing. When the user selects the icon designating printing, the receiving part 210 sets the selected user to an account name and then displays a login screen for inputting user identifying information used for authentication of the user.

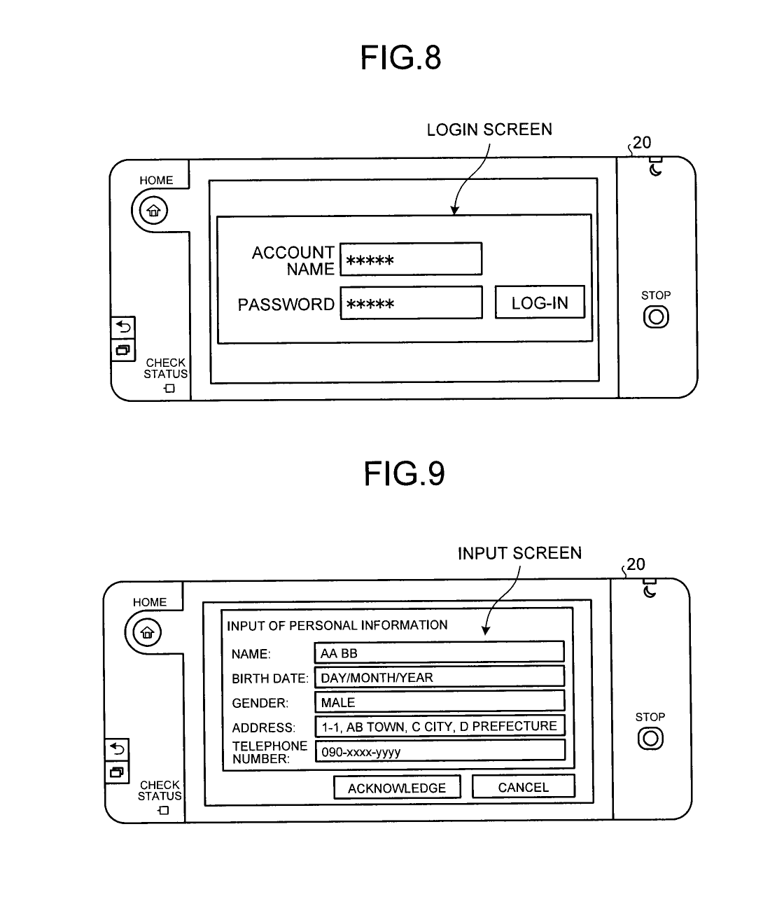

FIG. 8 is a schematic diagram illustrating an example of the login screen. In the example of FIG. 8, the user identifying information is composed of the account name and the password that are allocated for each user, but the embodiment is not limited thereto. When receiving the input of an account name and a password after the user inputs the password, the authentication control part 240 determines whether or not the information is present that is the set of the account name and the password and coincides with the received account name and password (the user identifying information) in the sets of the account name and the password retained (registered) by the storage 310 of the server 30. If the coinciding information, which is the set of the account name and the password, is present, the authentication control part 240 determines that the user is to be authenticated. If no coinciding information, which is the set of the account name and the password, is present, the authentication control part 240 determines that the user fails to be authenticated. Thereafter, the user selection screen illustrated in FIG. 7 is displayed again. When the authentication control part 240 determines that the user is to be authenticated, the printing control part 270 produces data for printing and prints the submission document. In the data for printing, personal information corresponding to an input item included in the submission form information is input to the input item from a personal information group including one or more pieces of preliminarily registered personal information.

The details of the processing to print a submission form and an acquisition method of a submission form are described later.

FIG. 9 is a schematic diagram illustrating an example of a screen for inputting the personal information. As illustrated in FIG. 9, the user preliminarily inputs his/her name, birth date, gender, address, and telephone number, for example, so as to register his/her personal information. The input personal information is retained by the authentication control part 240. Examples of the personal information to be registered include at least the name, the age, the birth date, the gender, the address, and the telephone number, but the items to be registered are not limited to these and any items may be set as the personal information. Furthermore, image data such as identification (ID) photograph data can also be registered as the personal information, thereby making it possible to produce and print a submission document to which an ID photograph is attached. When the personal information is registered, the account name corresponding to the user is retained by the authentication control part 240 together with the personal information.

After the completion of the registration of the personal information, the submission form acquisition part 250, which is described later, acquires the submission form information coinciding with the submission form information about the submission documents of the community and the public office associated with the registered address (e.g., the name of the prefecture or the name of the city) by searching a list of the submission form information about the submission document retained by the storage 310 of the server 30, for example.

The authentication control part 240 performs control in relation to authentication of users. The term authentication means that the user is authorized to use an application for printing the submission document, for example. In the embodiment, the authentication control part 240 instructs the display part 220 to display the login screen illustrated in FIG. 8 for promoting the user to input the user identifying information used for authenticating the user. In the example of FIG. 8, the user identifying information is composed of the account name and the password that are allocated for each user, but the embodiment is not limited thereto. When receiving the input of the account name and the password, the authentication control part 240 determines whether or not the information is present that is the set of the account name and the password and coincides with the received account name and password (the user identifying information) in the sets of the account name and the password retained (registered) by the storage 310 of the server 30. If the coinciding information is present, the authentication control part 240 performs control for authentication. In the embodiment, the authentication is required with the input of the account name and the password, when the personal information data is input, when the submission form is acquired, and when the submission form is printed. The authentication control part 240 retains the account name corresponding to the user together with the personal information data.

When determining that the user is to be authenticated, the authentication control part 240 transfers the authentication result of the user being rightly authenticated to the submission form acquisition part 250 and the printing control part 270.

Referring back to FIG. 3, the submission form acquisition part 250 performs control in relation to the acquisition of the submission form information.

Specifically, the submission form acquisition part 250 acquires, from the server 30, the submission form information including at least the template of the submission document and the updating information indicating the updating time point. In the embodiment, when receiving the authentication result of the user being rightly authenticated by the authentication control part 240, the submission form acquisition part 250 requests the server 30 to provide the submission form information about the submission document. When acquiring the submission form information about the submission document from the server 30, the submission form acquisition part 250 instructs the display part 220 to display the acquired submission form information. The submission form information includes the type of the submission document, the template (submission form) of the submission document, information about the updated date of the submission form, and information about the location (address) and the territory in charge of the public office, for example.

The submission form acquisition part 250 acquires, from the servers 60 installed in communities and public offices, the submission form information including at least the template of the submission document, which differs among communities and among public offices, and the updating information indicating the updating time point. The submission form acquisition part 250 causes the storage 310 of the server 30 to retain the acquired submission form information about the submission document as a submission form information list, for example. When the acquired submission form information is not retained by the storage 310, the submission form acquisition part 250 adds the acquired submission form information to the submission form information list.

When the receiving part 210 receives the instruction to print the submission document, the submission form acquisition part 250 acquires the submission form information including at least the template of the submission document, which differs among communities and among public offices, and the updating information indicating the updating time point.

When the receiving part 210 receives the instruction to print the submission document, the submission form acquisition part 250 acquires the submission form information including at least the templates of the submission documents of the community and the public office associated with the personal information corresponding to the user designated by the receiving part 210, and the updating information indicating the updating time point.

When acquiring the submission form information about the submission document, the submission form acquisition part 250 adds tag information to the input items included in the submission form information and causes the storage 310 to retain the resulting information. The tag information is a word (mark data) associated with an entry item in the submission form. For example, the tag information is information data such as an address, a name, an age, a birth date, a telephone number, and a photograph, corresponding to the respective entry items. The tag information is at least one of the address, the name, the age, the birth date, the gender, the telephone number, and the photograph.

The submission form acquisition part 250 extracts and acquires the submission form information about the submission documents of the community and the public office associated with the personal information from the submission form information retained by the storage 310 on the basis of the personal information corresponding to the user designated by the receiving part 210. Specifically, the submission form acquisition part 250 identifies the community and the public office corresponding to the address from address information in the personal information corresponding to the designated user, and then extracts and acquires the submission form information about the submission documents of the identified community and public office from the storage 310.

The submission form acquisition part 250 acquires the submission form information about the submission document after the authentication control part 240 performs the user authentication.

Referring back to FIG. 3, the updating part 260 compares the updating information about the preliminarily retained submission form information with the updating information about the submission form information acquired by the submission form acquisition part 250, the submission form information including at least the template of the submission document, which differs among communities and among public offices, and the updating information indicating the updating time point. If the acquired updating information is newer than the other, the updating part 260 updates the submission form information about the submission document. Specifically, the updating part 260 compares the updated date included in the updating information about the preliminarily retained submission form information with the updated date included in the updating information about the submission form information acquired by the submission form acquisition part 250. If the updated date of the acquired submission form information is newer than the other, the updating part 260 updates the retained submission form information about the submission document.

The updating part 260 updates the submission form information retained by the storage 310 to the newly acquired submission form information about the submission document and causes the storage 310 to retain the updated information.

Referring back to FIG. 3, the printing control part 270 controls the printing processing of the submission form. Specifically, when the receiving part 210 receives the instruction to print the submission document, the printing control part 270 produces the data for printing and prints the submission document. In the data for printing, the personal information corresponding to an input item included in the submission form information is input to the input item from the personal information group including one or more pieces of preliminarily registered personal information. For example, when the input items for filling the address, the name, the age, the birth date, and the telephone number are included in the submission form, the printing control part 270 automatically extracts the corresponding information from the personal information group on the basis of the added tag information and produces the data for printing in which the corresponding information is input to the respective input items in the submission form.

The printing control part 270 extracts the personal information corresponding to the tag information from the personal information group, and replaces the tag information with the extracted personal information, thereby producing the data for printing.

The printing control part 270 produces the data for printing and prints the submission document after the authentication control part 240 performs the user authentication.

The following describes an example of the processing operation of the printing control part 270 to print the submission form using the submission document simple printing application. The following description is based on the assumption that the submission document simple printing application is already started.

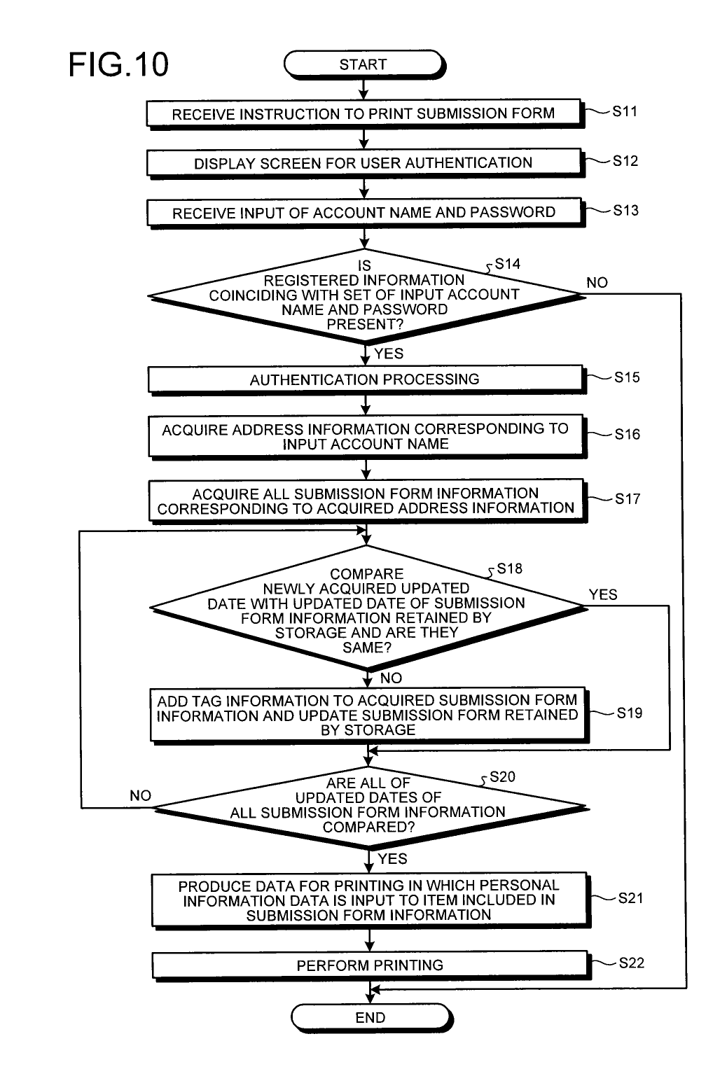

FIG. 10 is a flowchart illustrating an example of the processing operation when the instruction for printing is received. The receiving part 210 receives the instruction for printing when the icon designating the printing of the submission form is selected in the selection screen of the display part 220 illustrated in FIG. 5 by the user's operation (step S11). The display part 220 displays the user authentication screen (login screen) illustrated in FIG. 8 when the instruction for printing is received (step S12). The receiving part 210 receives the input of the account name and the password by the user's operation from the user authentication screen (login screen) (step S13).

The authentication control part 240 determines whether or not the registered information is present that is the set of the account name and the password preliminarily retained (registered) by the storage 310 of the server 30 and coincides with the set of the input account name and password (step S14). If no coinciding registered information is present (No at step S14), the authentication control part 240 determines that the user fails to be authenticated, and the printing control part 270 ends the printing processing. If the coinciding registered information is present (Yes at step S14), the authentication control part 240 determines that the user is to be authenticated and performs the authentication processing (step S15).

The submission form acquisition part 250 identifies the user corresponding to the input account name and acquires the address information about the identified user from the data in the personal information group retained by the authentication control part 240 (step S16). The submission form acquisition part 250 acquires, from the servers 60 installed in the community and the public office corresponding to the acquired address information, the submission form information about all of the relevant submission documents (step S17).

The updating part 260 compares the updated date of the submission form information about the corresponding submission document retained by the storage 310 with the updated date of the newly acquired submission form information about the submission document, and determines whether the updated dates are the same (step S18). If the updated dates are the same (Yes at step S18), the processing proceeds to step S20 to continue the processing. If the updated dates are not the same (the updated date of the newly acquired one is newer than the other) (No at step S18), the submission form acquisition part 250 adds the tag information to the newly acquired submission form information about the submission document, and the updating part 260 updates the submission form information retained by the storage 310 to the newly acquired submission form information and causes the storage 310 to retain the updated information (step S19).

The submission form acquisition part 250 determines whether all of the updated dates of the submission form information about all of the submission documents are compared (step S20). If not all of the updated dates are compared (No at step S20), the processing returns to step S18, at which the submission form acquisition part 250 continues the processing. If all of the updated dates are compared (Yes at step S20), the printing control part 270 produces the data for printing in which the personal information is input to the corresponding input items included in the submission form information (step S21). Specifically, the printing control part 270 produces the data for printing in which the personal information corresponding to the input items included in the submission form information is input to the input items from the personal information group including one or more pieces of preliminarily registered personal information. The printing control part 270 prints the produced data for printing (step S22), and thereafter the processing ends.

The following describes the processing to produce the data for printing in which the personal information is input to the respective input items included in the submission form information. The input of the personal information to the input items included in the submission form information is to produce the data for printing in which the personal information corresponding to the input items included in the submission form information is input to the input items from the personal information group including one or more pieces of preliminarily registered personal information. When the input items for filling the address, the name, the age, the birth date, and the telephone number are included in the submission form, the printing control part 270 automatically extracts the corresponding personal information from the personal information group on the basis of the added tag information and produces the data for printing in which the corresponding personal information is input to the respective input items in the submission form. The processing to produce the data for printing is the processing at step S21 of FIG. 10.

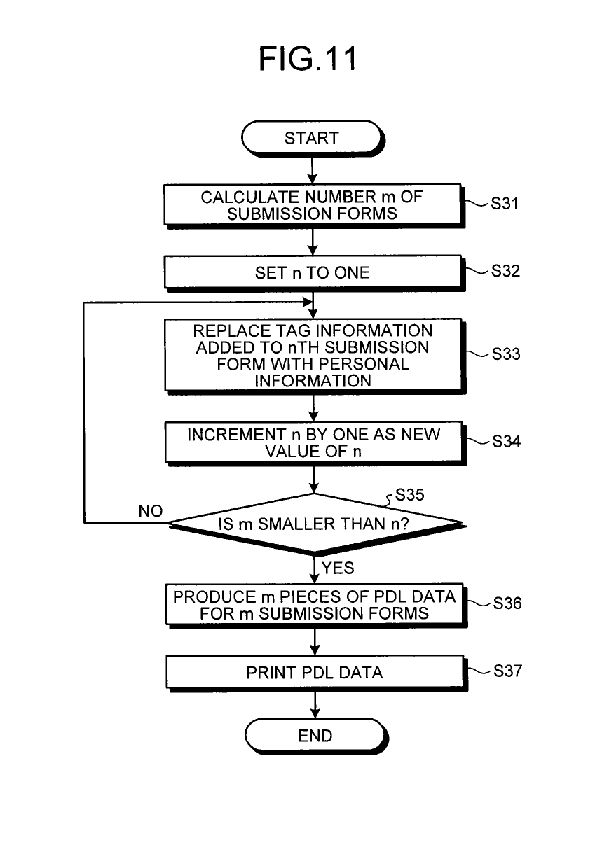

FIG. 11 is a flowchart illustrating the processing to produce the data for printing in which the personal information corresponding to the respective input items included in the submission form information is input to the input items from the personal information group. The printing control part 270 calculates the number m of submission forms of the submission documents (step S31). The printing control part 270 sets an initial value of n, which indicates the number of counted sheets of the submission forms, to one (n=1) (step S32). The tag information such as the address, the name, the age, the birth date, the gender, and the telephone number is added to the submission form.

The printing control part 270 performs processing to replace the tag information added to the nth submission form with the personal information as described later (step S33). The replacement of the tag information with the personal information is to automatically extract the personal information corresponding to the input item included in the submission form from the personal information group including one or more pieces of personal information on the basis of the tag information added to the submission form information, and produce the data for printing in which the personal information is input to the input item included in the submission form. The printing control part 270 sets n to n+1 (increments n, which is the number of counts, by one) as a new value of n (step S34). The printing control part 270 determines whether or not the number m of submission forms is smaller than the number n of counts (m<n) (step S35). If m is not smaller than n (No at step S35), the processing returns to step S33 to continue the processing. If m is smaller than n (Yes at step S35), the printing control part 270 produces m pieces of page description language (PDL) data (data for printing) in relation to the m submission forms (step S36). The printing control part 270 prints the produced m pieces of PDL data (date for printing) (step S37), and thereafter the processing ends. The data for printing produced by the printing control part 270 is not limited to the PDL data, and any data is applicable.

Referring back to FIG. 3, the communication part 280 exchanges data with the server 30 and the servers 60 installed in communities and public offices via the network 40. Specifically, the communication part 280 receives data of the submission form information about the submission document retained by the servers 60 installed in communities and public offices. The communication part 280 exchanges the data of the submission form information about the submission document with the server 30. The communication part 280 exchanges the data of the authentication information with the server 30.

The respective functions of the receiving part 210, the display part 220, the start processing part 230, the authentication control part 240, the submission form acquisition part 250, the printing control part 270, and the communication part 280 are achieved by the CPU 21 executing a computer program stored in the ROM 22 or the flash memory 24, for example, using the RAM 23 as a working area, but the embodiment is not limited thereto. For example, at least part of the respective functions of the operation unit 20 may be achieved by a dedicated hardware circuit (e.g., a semiconductor integrated circuit).

The function of the server 30 is described below. As illustrated in FIG. 3, the server 30 includes a storage 310 and a communication part 320.

The storage 310 retains the submission form information including at least the template of the submission document and the updating information indicating the updating time point that are acquired by the submission form acquisition part 250 from the servers 60 installed in communities and public offices. Specifically, the storage 310 adds the tag information to the submission form information and retains the submission form information when acquiring the submission form information about the submission document. The tag information is at least one of the address, the name, the age, the birth date, the gender, the telephone number, and the photograph. The submission form information including at least the template of the submission document and the updating information indicating the updating time point, which is retained by the storage 310, includes the type of the submission document, the template (submission form) of the submission document, information about the updated date of the submission form (updating information indicating the updating time point), and information about the address, for example.

When receiving, from the submission form acquisition part 250, the inquiry of the updated date of the submission form information about the submission documents retained by the storage 310, the storage 310 extracts the updated date of the submission form information about the submission documents of the community and the public office associated with the personal information data corresponding to the user designated by the receiving part 210, and transfers the result to the submission form acquisition part 250.

The storage 310 also retains the set of the account name and the password (user identifying information) that is preliminarily received by the receiving part 210 as the input. When receiving, from the authentication control part 240, the inquiry of whether the information is present that is the set of the account name and the password retained (registered) by the storage 310 and coincides with the set of the input account name and password, the storage 310 transfers the result to the authentication control part 240.

The communication part 320 exchanges various types of data with the MFP 1 and the servers 60 installed in communities and public offices via the network 40. Specifically, the communication part 320 exchanges the data of the submission form information about the submission document with the MFP 1, for example. The communication part 320 exchanges the authentication information with the MFP 1.

The function of the server 60 is described below. As illustrated in FIG. 3, the server 60 includes a communication part 350 and a storage 360.

The communication part 350 exchanges various types of data with the MFP 1 and the server 30 via the network 40. Specifically, the communication part 350 exchanges the data of the submission form information about the submission document with the MFP 1, for example.

The storage 360 retains the submission form information including at least the template of submission document, which differs among communities and among public offices, and the updating information indicating the updating time point. When updating the submission form information, the storage 360 updates the updating information indicating the updating time point, and then updates the submission form information including at least the template of the latest submission document and the updating information indicating the updating time point to retain them.

When receiving, from the MFP 1, the request of providing the submission form information about the submission document, the storage 360 transmits the submission form information including at least the template of the latest submission document and the updating information indicating the updating time point to the MFP 1 via the communication part 350.

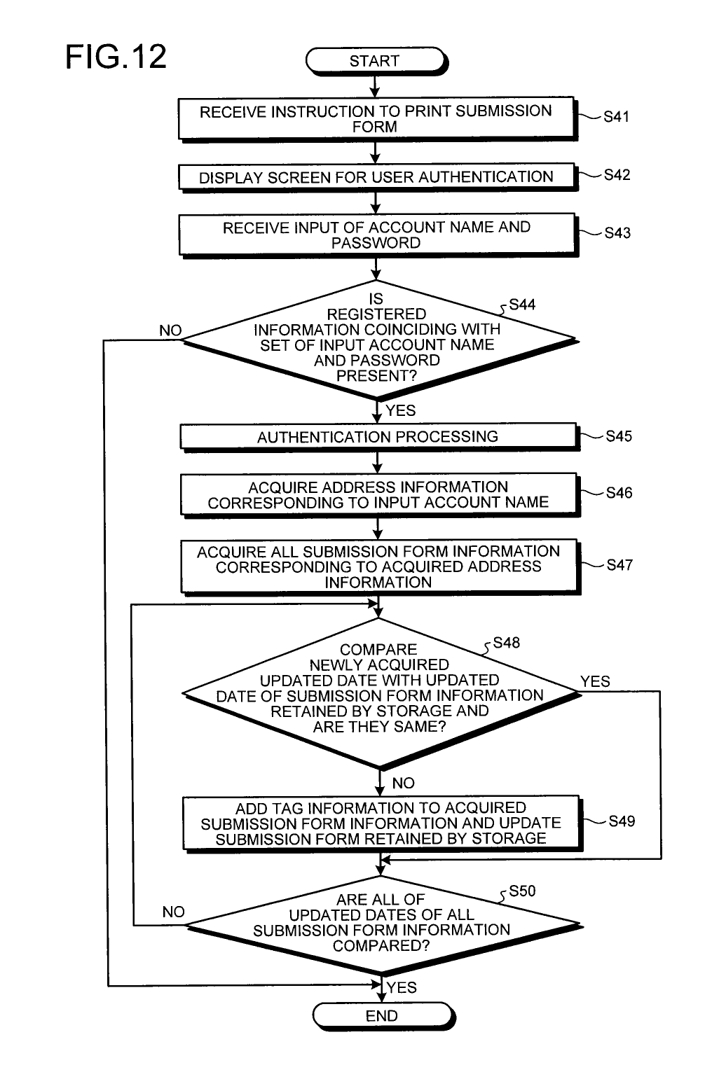

The following describes a method for acquiring the submission form information from the servers 60 installed in communities and public offices. FIG. 12 is a flowchart illustrating an example of the processing operation to acquire the submission form information from the server installed in a community or a public office. The following describes an example of the processing operation of the submission form acquisition part 250 when a user uses the submission document simple printing application. The following description is based on the assumption that the submission document simple printing application is already started.

The receiving part 210 receives the acquisition instruction when the icon designating the acquisition of the submission form is selected in the selection screen of the display part 220 illustrated in FIG. 5 by the user's operation (step S41). The display part 220 displays the user authentication screen (login screen) illustrated in FIG. 8 when the instruction for printing is received (step S42). The receiving part 210 receives the input of the account name and the password by the user's operation from the user authentication screen (login screen) (step S43).

The authentication control part 240 determines whether the registered information is present that is the set of the account name and the password preliminarily retained (registered) by the storage 310 of the server 30 and coincides with the set of the input account name and password (step S44). If no coinciding registered information is present (No at step S44), the authentication control part 240 determines that the user fails to be authenticated, and the submission form acquisition part 250 ends the acquisition processing of the submission form information about the submission document. If the coinciding registered information is present (Yes at step S44), the authentication control part 240 determines that the user is to be authenticated and performs the authentication processing (step S45).

The submission form acquisition part 250 identifies the user corresponding to the input account name and acquires the address information about the identified user from the data in the personal information group retained by the authentication control part 240 (step S46). The submission form acquisition part 250 acquires, from the servers 60 installed in the community and the public office corresponding to the acquired address information, the submission form information about all of the relevant submission documents (step S47).

The updating part 260 compares the updated date of the submission form information about the submission document retained by the storage 310 with the updated date of the newly acquired submission form information about the submission document, and determines whether or not the updated dates are the same (step S48). If the updated dates are the same (Yes at step S48), the processing proceeds to step S50 to continue the processing. If the updated dates are not the same (the updated date of the newly acquired one is newer than the other) (No at step S48), the submission form acquisition part 250 adds the tag information to the newly acquired submission form information about the submission document, and the updating part 260 updates the submission form information retained by the storage 310 to the newly acquired submission form information and causes the storage 310 to retain the updated information (step S49).

The submission form acquisition part 250 determines whether or not all of the updated dates of the submission form information about all of the submission documents are compared (step S51). If not all of the updated dates are compared (No at step S50), the processing returns to step S48, at which the submission form acquisition part 250 continues the processing. If all of the updated dates are compared (Yes at step S50), the processing ends.

As described above, in the embodiment, when the simple printing application for submission forms of submission documents of respective communities and offices is executed and the instruction is issued to print the submission form of a submission document, the user authentication is performed. The submission form information including at least the templates of the submission documents of the community and the public office associated with the personal information and the updating information indicating the updating time point is then extracted and acquired from the submission form information retained by the storage 310 on the basis of the personal information corresponding to the user. The latest updating information about the submission form information is then acquired, the latest updating information is compared with the updated date of the submission form information retained by the storage 310, and when the latest updated date is newer than the other, the latest submission form information is acquired and the retained submission form information is updated to the latest submission form information. The personal information corresponding to the tag information included in the submission form information is then extracted from the personal information group, and the tag information is replaced with the extracted personal information, thereby producing the data for printing. The embodiment thus can achieve an advantageous effect of being capable of producing various types of submission documents by acquiring the latest templates of the submission forms of the submission documents differing among communities and among public offices.

The present invention is not limited to the aforementioned embodiment, and may be realized, in producing step, by modifying the constituents in the scope of the invention. In the present invention, a few constituents out of all of the constituents disclosed in the above-mentioned embodiment may be omitted, and the constituents may properly be combined.

For example, the submission form acquisition part 250, the printing control part 270, and the storage 310 may be separated and included in the MFP 1 and the server 30. For another example, the submission form acquisition part 250, the printing control part 270, and the storage 310 may be separated and included in the MFP 1, the server 30, and one or more external apparatuses (e.g., servers).

The information processing system 100 according to the invention should include at least the submission form acquisition part 250, the printing control part 270, and the storage 310. The submission form acquisition part 250 acquires the submission form information about the submission documents differing among communities and among public offices. When the receiving part 210 receives the instruction to print the submission document, the printing control part 270 produces the data for printing and prints the submission document. In the data for printing, the personal information corresponding to an input item included in the submission form information is input to the input item from the personal information group including one or more pieces of preliminarily registered personal information. Specifically, when the receiving part 210 receives the instruction to print the submission document, the printing control part 270 produces the data for printing and prints the submission document. In the data for printing, the personal information corresponding to an input item included in the submission form information is input to the input item from the personal information group including one or more pieces of preliminarily registered personal information. The storage 310 retains the acquired submission form information. The storage 310 also retains the set of the account name and the password (user identifying information) that is preliminarily received by the receiving part 210 as the input.

In the embodiment, the main body 10 and the operation unit 20 operate under the different operating systems, but the embodiment is not limited thereto. For example, the main body 10 and the operation unit 20 may operate under the same operating system.

A computer program executed by the information processing system 100 of the embodiment may be recorded and provided in a computer-readable recording medium such as a compact disc ROM (CD-ROM), a flexible disk (FD), a CD-recordable (CD-R), a digital versatile disc (DVD), and a universal serial bus (USB), as an installable or executable file. The program may be provided or distributed via a network such as the Internet. The various programs may be embedded and provided in a ROM, for example.

The system structure, in which the MFP 1, the server 30, and the servers 60 installed in communities and public offices are connected, of the embodiment is an example. Various system structures are applicable depending on usages and purposes.

The invention has an advantageous effect of being capable of producing various submission documents by acquiring the latest submission forms of the templates of the submission documents, which differ among communities and public offices.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system, comprising:
a receiving part that receives operation of a user;
a submission form acquisition part that acquires submission form information including at least a template of a submission document differing among communities and among public offices and updating information indicating an updating time point, when the receiving part receives an instruction to print the submission document;
an updating part that compares the updating information about the submission form information preliminarily retained with the updating information about the acquired submission form information, and updates the submission form information about the submission document when the acquired updating information is newer than the updating information about the submission form information preliminarily retained; and
a printing control part that produces data for printing in which personal information corresponding to an input item included in the submission form information is input to the input item from a personal information group including one or more pieces of preliminarily registered personal information, and prints the submission document.

2. The information processing system according to claim 1, wherein
when the receiving part receives the instruction to print submission document, the submission form acquisition part acquires the submission form information about the submission documents of the community and the public office that are associated with the personal information corresponding to the user designated by the receiving part.

3. The information processing system according to claim 1, further comprising
a storage that retains the acquired submission form information, wherein
when receiving the submission form information about the submission document, the submission form acquisition part adds tag information to the input item included in the submission form information, and causes the storage to retain the resulting submission form information, and
the printing control part extracts the personal information corresponding to the tag information from the personal information group, and replaces the tag information with the extracted personal information to produce the data for printing.

4. The information processing system according to claim 3, wherein
the tag information is at least one of an address, a name, an age, a birth date, a gender, a telephone number, and a photograph.

5. The information processing system according to claim 3, wherein
the submission form acquisition part extracts and acquires the submission form information about submission documents of the community and the public office that are associated with the personal information from the submission form information retained by the storage on the basis of the personal information corresponding to the user designated by the receiving part.

6. The information processing system according to claim 1, further comprising
an authentication control part that performs control in relation to authentication of a user, wherein
the submission form acquisition part acquires the submission form information about the submission document after the authentication control part performs the authentication of the user, and
the printing control part produces the data for printing and prints the submission document.

7. An information processing apparatus, comprising:
a receiving part that receives operation of a user;
a display part that displays various images;
an authentication control part that performs control in relation to authentication of a user;
a submission form acquisition part that acquires submission form information including at least a template of a submission document differing among communities and among public offices and updating information indicating an updating time point, when the receiving part receives an instruction to print the submission document;
an updating part that compares the updating information about the submission form information preliminarily retained with the updating information about the acquired submission form information, and updates the submission form information about the submission document when the acquired updating information is newer than the updating information about the submission form information preliminarily retained;
a storage that retains the acquired submission form information;
a printing control part that produces data for printing in which personal information corresponding to an input item included in the submission form information is input to the input item from a personal information group including one or more pieces of preliminarily registered personal information after the authentication control part performs the authentication of the user when the receiving part receives the instruction to print the submission document, and prints the submission document; and
a communication part that exchanges various types of data with an external apparatus.

8. An information processing method, comprising:
receiving operation of a user;
acquiring submission form information including at least a template of a submission document differing among communities and among public offices and updating information indicating an updating time point, when an instruction to print the submission document is received at the receiving;
comparing the updating information about the submission form information preliminarily retained with the updating information about the acquired submission form information, and updating the submission form information about the submission document when the acquired updating information is newer than the updating information about the submission form information preliminarily retained; and
producing data for printing in which personal information corresponding to an input item included in the submission form information is input to the input item from a personal information group including one or more pieces of preliminarily registered personal information, and printing the submission document.
